(19) United States
(12) Patent Application Publication
(10) Pub. No.: US 2017/0046626 A1
(43) Pub. Date: Feb. 16, 2017

(54) SYSTEM AND METHOD FOR EX POST COUNTERFACTUAL SIMULATION

(71) Applicant: King Abdullah Petroleum Studies and Research Center, Riyadh (SA)

(72) Inventors: Rubal DUA, Riyadh (SA); Kenneth J. WHITE, Riyadh (SA); Daniel MABREY, Riyadh (SA); Rebecca A. LINDLAND, Riyadh (SA)

(21) Appl. No.: 15/228,154

(22) Filed: Aug. 4, 2016

Related U.S. Application Data
(60) Provisional application No. 62/203,043, filed on Aug. 10, 2015.

(51) Int. Cl. G06N 99/00; G06N 7/00

(52) U.S. Cl. CPC G06N 99/005; G06N 7/005

(57) ABSTRACT

A system and method for ex post counterfactual simulation to identify and estimate the non-members who could counterfactually be categorized in a specific group of interest, based on probabilistically matching “nearest” non-members to the group of interest.

### RELATED APPLICATION

The present application claims the benefit of U.S. Provisional Patent Application No. 62/203,043 filed on 10 Aug. 2015, the disclosure of which is incorporated herein by reference in its entireties.

### FIELD OF THE INVENTION

This invention relates to a system and method for predictive analytics, and more specifically to an ex post counterfactual simulation to identify and estimate the non-members who could counterfactually be categorized in a specific group of interest, based on probabilistically matching “nearest” non-members to the group of interest.

### BACKGROUND OF THE INVENTION

In the prior art, segmentation and clustering methods have sought to differentiate those non-members of a group who are more likely to become members. Many techniques exist for such differentiation, including, especially in the context of marketing, techniques related to geographic factors, e.g., determining those living near existing group members; demographic factors, e.g., determining those non-members who have incomes, family size, etc., that more closely correspond to the characteristics of existing group members; and psychographic/lifestyle factors, e.g., determining those non-members whose lifestyles more closely correspond to those of existing group members.

Once the differentiating factors are identified, another challenge of the operator of a predictive analytics system is to determine, given the communication medium selected, how best to target non-members in an attempt to encourage them to become group members, when that is the goal, while minimizing the time and money spent on non-members who are less likely to become group members. This can include purchasing advertising in a particular medium or media to best reach the targeted non-members, purchasing subscription mailing lists of publications to which these non-members subscribe, and many other means. The operator of a predictive analytics system can also adjust the nature of the membership, i.e., redesign the product or revise the service, to better match the interests of the prospective members.

Clustering methods typically assign individuals or groups to one of a number of discrete segments or clusters based on a statistical “best fit” methodology that takes into account a number of the above factors.

Presumptions and correlations play a role in the success of any system for conducting predictive analytics. For example, a board of elections seeking to encourage a higher voting turnout may achieve better results by contacting subscribers to a publication or website of interest to the group, such as Politico, rather than contacting subscribers to People, because readers of Politico presumably have a stronger interest in politics. However, the gains of such an approach might not be great, since a subscriber to Politico would most likely already be a registered voter who regularly votes in elections.

Any new rapid, direct method to more accurately predict the ability to convert non-members of a group to members will save substantial expense, effort and time for both commercial and non-commercial parties. Therefore, a need exists for an improved electronic computer engine for predictive analytics.

### SUMMARY OF THE INVENTION

The invention segments a population of individuals into different groups and for a specific group of interest, identifies and estimates the numbers of non-members who could ex post, counterfactually, be categorized into that specific group. It is ex post because all the individuals have already taken a decision because of which they are categorized into specific groups. And it is counterfactual because the invention identifies those non-members who could have been categorized into a specific group of interest, although based on their decision they do not belong to that specific group of interest. Thus, the invention helps in ex post counterfactual simulation, i.e., speculating what the distribution of population within the different groups might have been had an appropriate intervention been made.

The invention has broad applicability in facilitating decision-making of users. One example occurs in health care, where the invention can be used to identify patients at risk of an illness, wherein an early intervention could help in preventing the onset of illness, or to identify patients who qualify for a new medical treatment. Another example includes estimating convertible voter share in elections, which would be of value to election campaign managers for identifying and targeting convertible voters.

The invention also has commercial applications, such as identifying and targeting potential customers, or estimating the market size for a newly introduced product.

The invention can also facilitate the identification and anticipation of low-probability, high-risk events, which can have both non-commercial, military or civil defense applications, as well as commercial applications for risk avoidance.

These are only a few examples of commercial and non-commercial applications of the invention, and the list is not intended to be limiting.

The above objects and further advantages are provided by the present invention which broadly comprehends a system, method, and computer program product for ex post counterfactual simulation to identify and estimate the non-members who could counterfactually be categorized in a specific group of interest, based on probabilistically matching “nearest” non-members to the group of interest.

### BRIEF DESCRIPTION OF THE DRAWINGS

The present invention will be further described with reference to the accompanying drawings in which:

FIG. 1 is a flowchart illustrating the steps of the invention;

FIG. 2 is a flowchart for segmentation analysis;

FIG. 3 is a flowchart for sizing analysis;

FIG. 4 is a schematic diagram for determining a hold-out dataset;

FIG. 5 is a schematic diagram for determining a hold-out dataset for combined neighborhood and realistic scenario conditions and for simultaneous prediction of potential buyers for vehicles of different fuel types;

FIG. 6 is a table of predicted market share for various scenarios within the respondent space; and

FIG. 7 is a table of predicted market share for various scenarios within the national market space.

FIG. 8 is a table of predicted market share within the national market space for two scenarios wherein competition among different fuel types and thus simultaneous prediction of potential buyers for different fuel types is allowed.

### DETAILED DESCRIPTION OF INVENTION

The invention facilitates identification of non-members who could ex post, counterfactually, be categorized into a particular group or a specific group of interest. The invention segments a population of individuals into different groups and for a specific group of interest, identifies and estimates the numbers of non-members who could ex post, counterfactually, be categorized into that specific group.

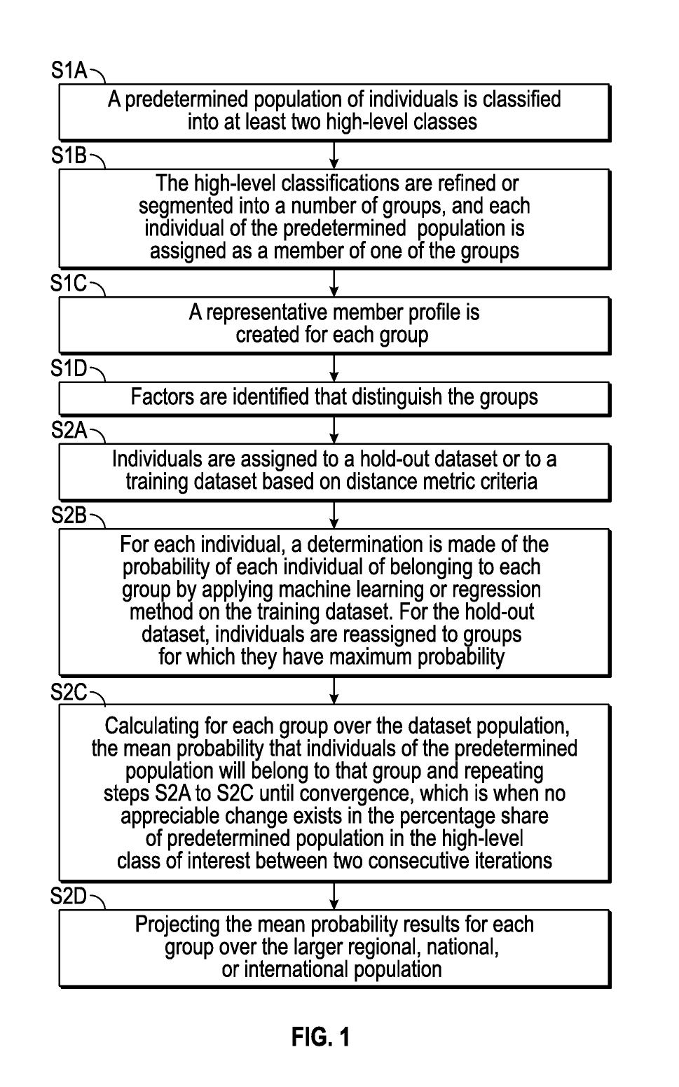

Referring to FIG. 1, a flowchart describing the steps of the invention is provided. In step S1A, a predetermined population of individuals, which can be a part of a larger regional, national, or international population, is classified into at least two high-level classes.

In step S1B, the high-level classifications of individuals are refined or segmented into a number of groups, with each individual of the predetermined population assigned as a member of one of the groups.

In step S1C, a representative member profile is created for each group.

In step S1D, factors are identified that distinguish the groups.

In step S2A, individuals are assigned to a hold-out dataset or a training dataset based on each individual's distance from the representative member profile created in step S1C

In step S2B, for each group, the probability of each individual belonging to that group is calculated using a machine learning or regression method applied on the training dataset. Within hold-out dataset, each individual is reassigned to a group for which it has maximum probability.

In step S2C, for each group over the dataset population, the mean probability that individuals of the predetermined population will belong to that group is calculated. Finally steps S2A-S2C are repeated until convergence, which is when no appreciable change occurs in the percentage share of predetermined population in the high-level class of interest between two consecutive iterations.

For those cases in which the predetermined population is a part of a larger regional, national, or international population, optional step S2D projects the mean probability results for each group over the larger regional, national, or international population.

The following description details a preferred embodiment of steps S1A-S2D, and also provides two examples of the application of this preferred embodiment. The first example, with both commercial and non-commercial benefits, is to apply the invention to identify vehicle buyers who could ex post, counterfactually, be categorized into a group of battery electric vehicle (BEV) buyers. In other words, this first example identifies potential BEV buyers.

In the method of steps S1A-S1D, classify individuals of a predetermined population into high-level classes, refine or segment the high-level classes of individuals into different groups and assign each individual as a member of one of the groups, establish a representative member profile for each group, and identify factors that distinguish the groups.

Identifying these factors or barriers to adoption of a new technology or feature can help guide manufacturers and policymakers to increase the adoption of energy efficient, advanced technology vehicles. In this example, the members are consumers who responded to a revealed preference survey after purchasing a new car. The specific group of interest refers to a group comprised of respondents who bought a BEV. Thus, the potential members are those respondents who belong to groups comprised of non-BEV buyers, but could be categorized into a group comprised of BEV buyers. These potential members, i.e., potential BEV buyers, are identified using the method of the present invention.

Steps S2A-S2D assign the individuals to a hold-out dataset or to a training dataset based on a distance metric criteria, calculate for each group the probability that each individual belongs to that group using a machine learning regression approach applied on the training dataset, reassign individuals within the hold-out dataset to the group for which it has maximum probability, calculate for each group the mean probability that individuals will belong to that group. Repeat steps S2A-S2C until convergence, which is when no appreciable change occurs in the percentage share of predetermined population in the high-level class of interest (i.e. the BEV class) between two consecutive iterations, and project the mean probability results for each group over a national population. By these steps, the total number of BEV buyers within the national market is estimated under various scenarios. Estimating the consumer demand is useful commercially for manufacturers who benefit by determining production volume for these vehicles, and is useful non-commercially for regulators responsible for setting policy targets.

I. Segmentation of Members into Different Groups

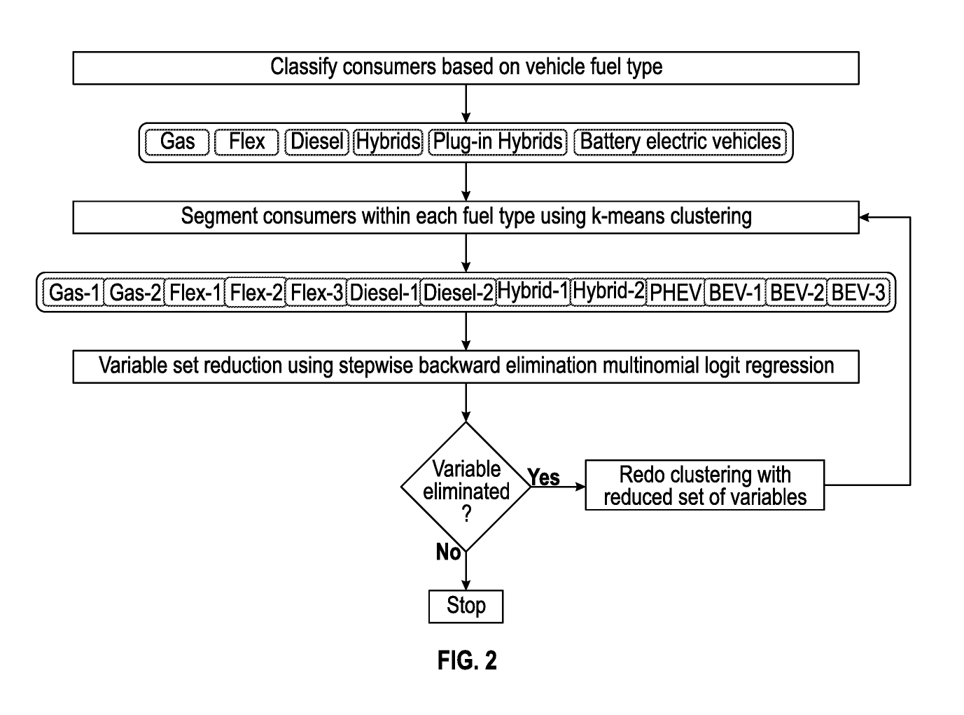

FIG. 2 is a flowchart depicting segmentation analysis, including steps S1A-S1D.

Step S1A: Classification of individuals into at least two high-level classes. The simplest classification can classify the consumers based on whether they bought a BEV or a non-BEV. Other high level classifications such as those based on the fuel type of the vehicle purchased can also be used. The demonstrative example described used classification based on the fuel-type of the vehicle purchased: gas, flex, diesel, hybrid, plug-in hybrid, and battery electric vehicles.

Step S1B: Refinement or segmentation of high-level classifications of individuals into a number of groups, and assignment of each individual into one of the groups. A clustering approach is utilized to refine or segment the high-level classifications into groups. For demonstrative purposes, a non-hierarchical k-Means clustering technique was paired with a correlation distance metric, but alternative clustering approaches, including latent class analysis, along with any distance metric, can be used.

To determine the optimum number of clusters for each fuel type vehicle, for demonstrative purposes the Calinski-Harabasz criterion is used, although Duda-Hart Je(2)/Je(1) or any other stopping criteria can be used, including the case of setting the optimum number of clusters to one. The clustering is performed using a revealed preference dataset, although any type of dataset can be used, where the type depends in large part on the specific application of the invention, i.e., healthcare, voting participation. The datasets will be managed by a conventional database management system, which are known in the art. The database management system can be run on a computer or on a network of computers, and comprise a processor, program storage memory and data storage memory including volatile and non-transitory memory, input/output devices, and support circuitry, which are conventional components that are known in the art.

In a test of this first example, a new vehicle experience survey from Strategic Vision Incorporation was used. From the survey data, two different sets of variables were chosen, namely: (i) purchase intentions, and (ii) demographic variables, although more and/or different sets of variables can also be used. A set of geography-related factors was also used in the analysis.

In this first example, this step established two clusters of gasoline-powered vehicle buyer groups (Gas-1 and Gas-2), three clusters of flex-fuel vehicle buyer groups (Flex-1, Flex-2, and Flex-3), two clusters of diesel vehicle buyer groups, two clusters of hybrid vehicle buyer groups (Hybrid-1 and Hybrid-2), single cluster of plug-in hybrid electric vehicle buyers and three clusters for battery electric vehicle buyer groups (BEV-1, BEV-2, and BEV-3).

Step S1C: Creation of a representative member profile for each group. Once the segmentation is complete, a representative buyer profile is designed for each group. For demonstrative purposes, for the segmentation carried out using k-Means clustering, the representative buyer profile is denoted by the centroid of the group. Thus, the value of each of the variables for the representative buyer is the average of the value of that variable for all the buyers within that group. This representative buyer will be referred to as an avatar in the description that follows.

Step S1D: Identification of factors distinguishing the groups. For demonstrative purposes, this step is completed using a stepwise multinomial logistic regression (MLR). As will be understood by one of ordinary skill in the art, any machine learning or regression approach can be used. The different groups are considered the dependent categorical variables, while the factors distinguishing the groups are considered the set of independent variables for the stepwise-MLR. A backward elimination scheme is used for the stepwise regression, although other schemes such as forward selection or bidirectional elimination can be used. The stopping criterion for the stepwise-MLR is when all coefficients have p-values less than 0.05. The clustering analysis is again repeated with the reduced set of variables remaining after the stepwise-MLR. Then, a stepwise-MLR is performed on the new set of clusters and these iterative steps of clustering and stepwise-MLR are performed until convergence. Convergence is achieved when no more variables are eliminated during stepwise-MLR between two consecutive iterations.

II. Identifying and Estimating the Numbers of Prospective Group Members

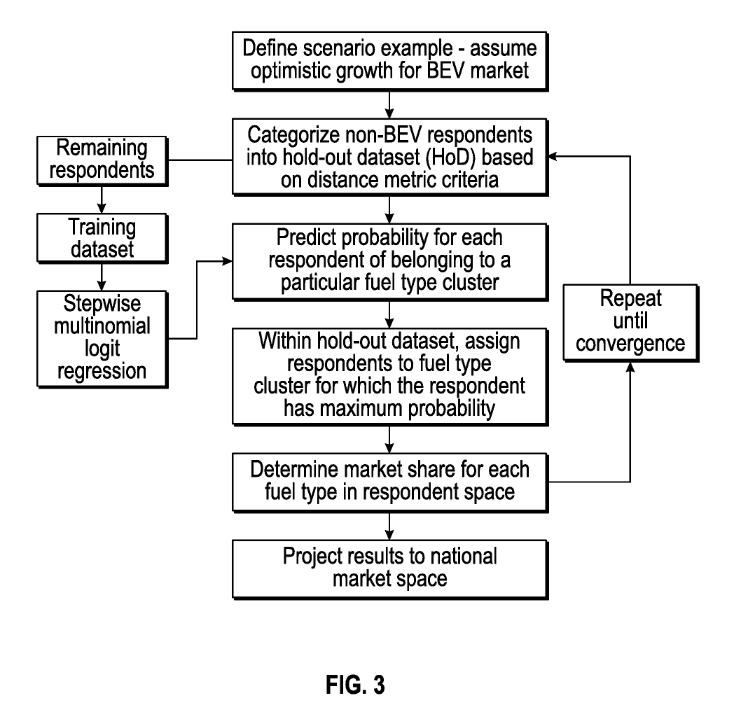

FIG. 3 is a flowchart for market sizing, including steps S2A-S2D.

Step S2A: Assigning individuals to a training dataset and to a hold-out dataset. The entire respondent population is separated into the training set and the hold-out dataset. The training set allows the constrained MLR model to be trained on the members of the group of interest, i.e., all survey respondents who bought a BEV, and on the “farthest” non-members. A set of so-called “nearest” non-members who could have purchased a BEV go into the “hold-out dataset,” so that in the practice of the method of the invention, individuals in the “hold-out” dataset can be moved from one fuel-type vehicle group to another.

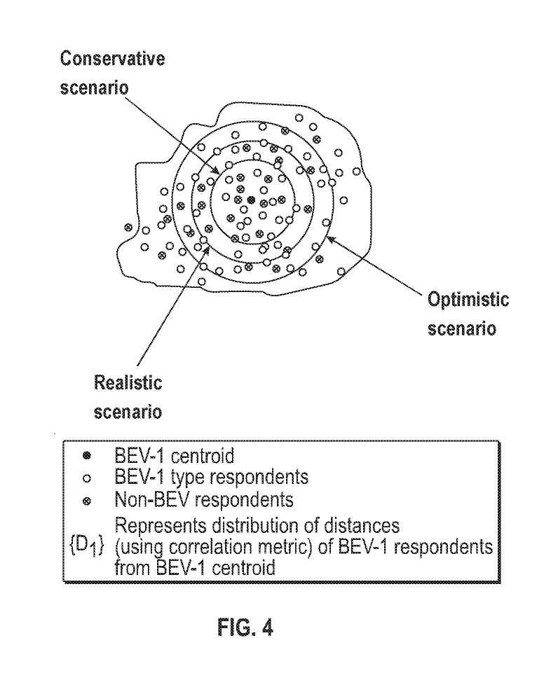

FIG. 4 is a schematic diagram describing how the hold-out dataset is categorized. For example, consider the BEV-1 cluster, where the BEV-1 centroid represents the BEV-1 avatar. First, the distance of each BEV-1 respondent and the BEV-1 centroid is measured. For demonstrative purposes, the distance metric is defined as 1-correlation(x,y), where the correlation is measured between the BEV-1 centroid's responses (x) and a BEV-1 respondent's responses (y), although any other distance metric can be used. The distribution of distances between all the BEV-1 respondents and the BEV-1 centroid is denoted by {D₁}. Then the average and standard deviation for this distance {D₁} distribution is measured. For demonstration purposes, the average and standard deviation numbers are used to define three different scenarios: the realistic, optimistic and conservative scenarios. Let r_{Real-1}=average{D₁}, r_{Opt-1}=average{D₁}+standard deviation{D₁}/2, r_{Cons-1}=average{D₁}−standard deviation{D₁}/2, although other scenario definitions could also be used For the realistic scenario case, all the non-BEV respondents within a distance of r_{Real-1} from the BEV-1 avatar are placed in the hold-out dataset.

The above set of steps are repeated for the other two established BEV clusters, with the non-BEV respondents within a distance of r_{Real-2} and r_{Real-3} from the BEV-2 and BEV-3 avatar, respectively, are placed in the hold-out dataset. Similarly, the hold-out datasets for the optimistic and conservative scenarios are identified using r_{Opt} and r_{Cons}, respectively. In addition to the criterion described above, other criteria can also be used to define these scenarios, such as the distance within which x % of actual cluster members lie and so on.

In addition to the three previous scenarios, one more scenario termed as the neighborhood scenario will be defined. To identify the hold-out dataset for the neighborhood scenario, the distance between each respondent and each cluster centroid/avatar is measured. Then, all the non-BEV respondents whose distance to a BEV avatar is the lowest as compared to non-BEV avatars, are placed in the hold-out dataset for the neighborhood scenario. Other scenarios involving combinations of conditions from the neighborhood scenario with optimistic or realistic or conservative scenarios can also be used.

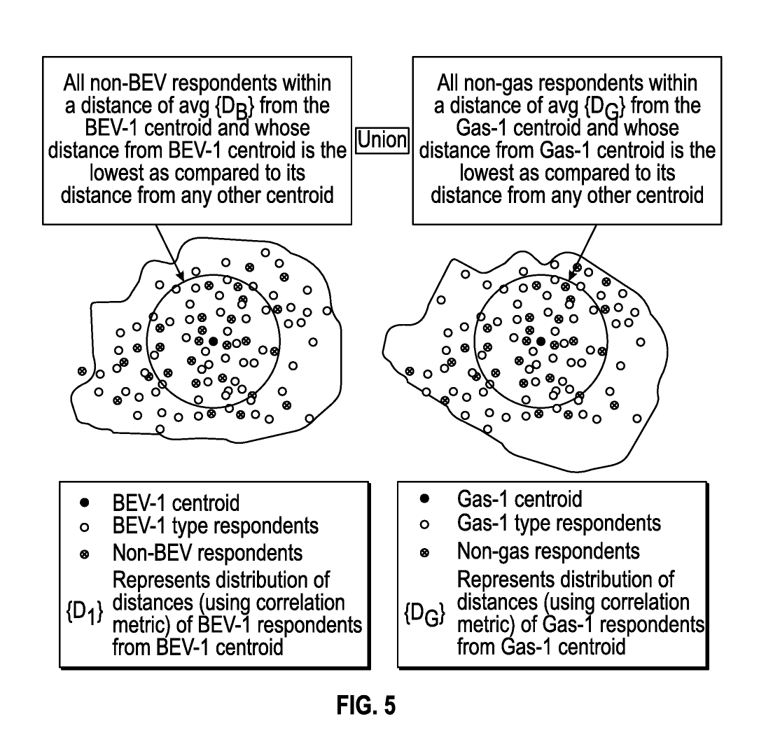

A simulation involving simultaneous prediction of potential buyers for various fuel type vehicles can also be conducted. FIG. 5 is a schematic diagram showing a combination of conditions from neighborhood and realistic scenarios for simultaneously predicting market shares of different fuel type vehicles. The hold-out dataset for the simultaneous prediction of potential buyers for different fuel type vehicles involves a merger of the hold-out dataset identified for each fuel type vehicle cluster.

Once the respondents in the hold-out dataset have been identified, all other respondents, i.e., the members of the group of interest and the “farthest” non-members, are assigned to the training dataset.

Step S2B: For each group, a determination is made as to the probability of each individual to belong to that group. Once the data has been partitioned, a stepwise-MLR is fitted to the training set in a similar way as previously described in step S1D. The trained stepwise-MLR model is used to determine the probability that each of the respondents belongs to each of the fuel type vehicle clusters. This determination is made not only for individuals who are already classified as members of a particular group, but also for individuals classified as members of other groups. P_{ijf}^{R,S} is used to denote the probability of the i^{th} respondent belonging to the j^{th} cluster of f^{th} fuel type vehicle within the respondent space (R) for scenario (S). Finally within the hold-out dataset, each i^{th} respondent is reassigned to the cluster for which it has the maximum probability. Thus, the fuel type for the i^{th} respondent is accordingly updated.

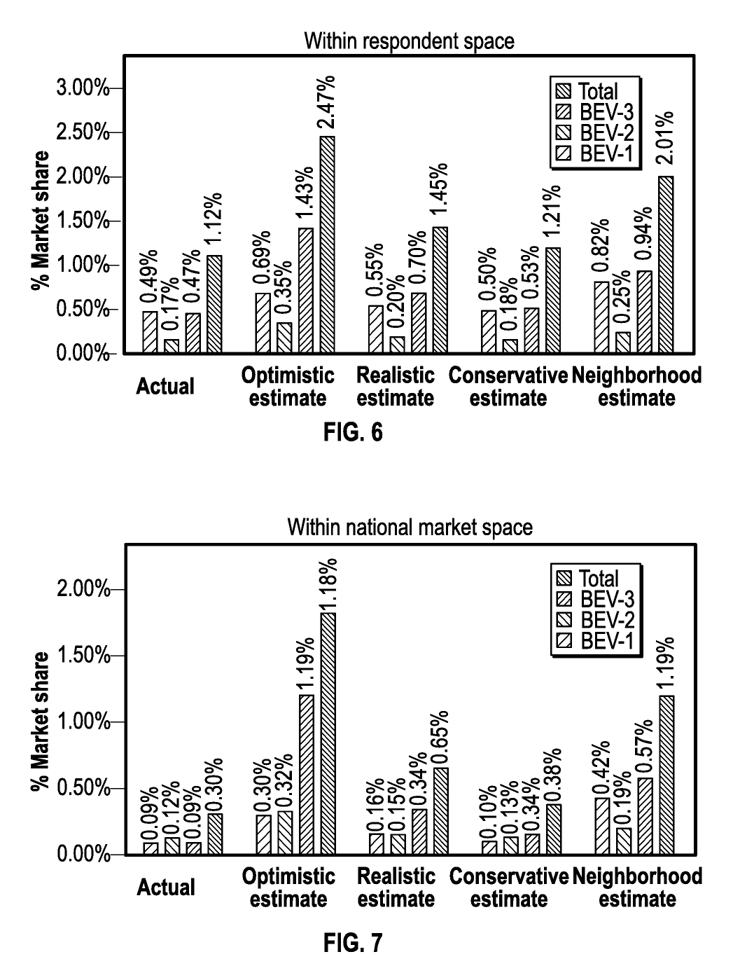

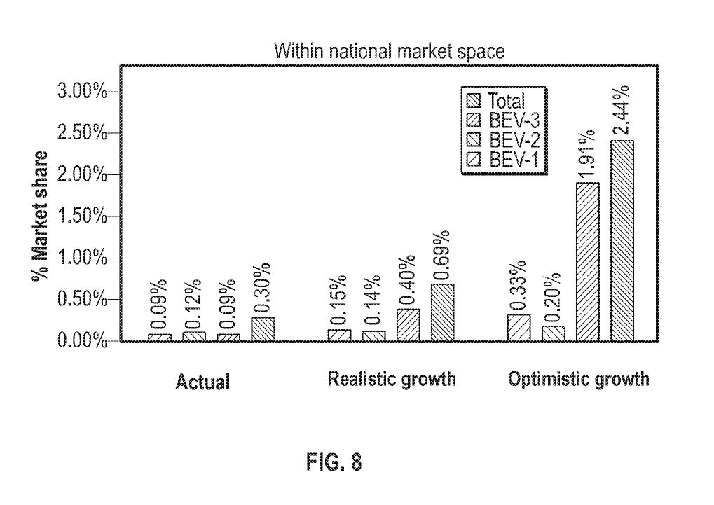

Step S2C: Calculating the mean probability for each group over the dataset population. For the converged iteration, the mean probability for each fuel type cluster over the entire population set in the respondent space is computed. Let P̅_{jf}^{R,S} denote the mean probability for j^{th} cluster of f^{th} fuel type vehicle within the respondent space for scenario S. Thus, P̅_{jf}^{R,S} is defined as

$${\overline{P}}_{jf}^{R , S} = \frac{{\sum }_{i = 1}^{N} {P}_{ijf}^{R , S}}{N} ,$$

where N represents the total number of respondents in the respondent space. The mean probability for each fuel type vehicle is then computed by summing over the mean probabilities for each cluster for that fuel type vehicle. Thus P_{f}^{R,S} is defined as P_{f}^{R,S}=ΣⱼP_{jf}^{R,S}. The value of P̅_{f}^{R,S} represents the predicted market share for each fuel type vehicle within the respondent space for scenario S. Finally steps S2A-S2C are repeated until convergence, which is when no appreciable change occurs in the predicted market share for BEV fuel type in the respondent space between two consecutive iterations. The predicted market share for various scenarios within the respondent space is shown in FIG. 6.

Step S2D: Projecting the mean probability results for each group over a larger population. The results obtained in step S2C are projected in a national market space using the weights associated with each respondent. This step is necessary when the raw survey data represents a sample rather than the entire population of the national market. For demonstrative purposes, the weights are defined as the ratio of total buyers for a particular vehicle within the national market to the number of respondents who bought the same vehicle within the survey population. Other ways of defining weights, such as weights based on sample demographics, can also be used. The mean probability of each fuel type cluster in the national market space, denoted by P̅_{jf}^{N,S}, is defined as

$${\overline{P}}_{jf}^{N , S} = \frac{{\sum }_{i = 1}^{N} {w}_{i} {P}_{ijf}^{R , S}}{{\sum }_{i = 1}^{N} {w}_{i}} ,$$

where wᵢ represents the weight associated with each respondent. Finally, the mean probability for each fuel type, denoted by P̅_{f}^{N,S} is defined as P̅_{f}^{N,S}=ΣⱼP̅_{jf}^{N,S}. This P̅_{f}^{N,S} represents the predicted market share for the each fuel type within the national market space for scenario S. The predicted market share for various scenarios within the national market space is shown in FIG. 7.

A second example of the application of the method of the invention is an election scenario with a plurality of candidates running for a single elective office or position. The election scenario is analogous to the different fuel type vehicles available for purchase by consumers. Imagine that a random survey of 15% of the voters is conducted.

Step S1A executes a classification of individuals into at least two high-level classes. In this second embodiment, this classification can segment the surveyed voter population based on the candidate for whom they have indicated support.

Step S1B executes a refinement or segmentation of the high-level classifications of individuals into a number of groups, and assigns each individual as a member of one group. In this second embodiment, this refinement or segmentation can be, for example, to cluster the voter population for each candidate based on voters' responses to survey questions which can include (i) reasons for voting, e.g., how much do they like their preferred candidate's policy on a particular issue, (ii) respondents' socio-economic and geographical conditions, and so on.

Step S1C creates a representative member profile for each group. In this second embodiment, after clusters of voters for each candidate are identified, the cluster centroids or avatars can be defined in a manner that is analogous to the fuel type avatars described in the first example.

Step S1D identifies factors separating the different groups. In this second embodiment, steps S2A-2D help in identifying potential voters for a particular candidate, along with policy modifications that would potentially encourage them to switch their support to a different candidate.

Step S2A separates the survey population into hold-out and training datasets, wherein the non-members that are statistically nearest to the representative member profile of group of interest are assigned to the hold-out dataset, while all other respondents are assigned to the training dataset.

Step S2B determines the probabilities that each individual belongs to each of the defined groups using a machine learning or regression method applied on the training dataset. In the context of this embodiment, data would be the probability that each surveyed voter will belong to a cluster of voters choosing to vote for a particular candidate. Now within the hold-out dataset, each respondent is reassigned to the cluster for which it has maximum probability.

Step S2C calculates the mean probability for each high-level group over the dataset population. In this embodiment, this would be the percentage of support for each group, i.e., for each candidate, based upon the survey conducted. Finally steps S2A-S2C are repeated until convergence, which is when no appreciable change occurs in the percentage of support for the candidate of interest between two consecutive iterations.

Finally, step S2D projects the results from the survey respondent space to the larger population. In this embodiment, the survey was 15% of the voters. Having analyzed this 15% of the voter population, the results of step S2C are projected to the entire population of voters who are registered for a particular election. This projection can be achieved using weights associated with each survey respondent, where the weight can be defined for each respondent based on the ratio of the number of eligible voters with a certain set of demographic conditions in the election area to the number of respondents with a similar set of demographic conditions within the survey poll area. Thus, the model serves to predict how much the voting share for a particular candidate could be increased and what policy changes by a candidate would likely produce an increase in the share of votes received.

One of ordinary skill in the art will also understand that an embodiment of the present invention can be provided in the form of a computer program product.

While the system and method of the present invention have been described above and with reference to the attached figures, modifications will be apparent to those of ordinary skill in the art. The scope of protection for the invention is to be defined by the claims that follow.

1. A method of generating a model for ex post counterfactual simulation, the model to be executed on data stored in a computer-readable dataset corresponding to a predetermined population of individuals, where the dataset is managed by a database management system, the method comprising:
executing a classification of the individuals into at least two high-level classes;
executing a refinement and/or segmentation of the high-level classifications of the individuals into a number of groups, and segmenting individuals within each high level classes into groups, using a clustering methodology;
creating a representative member profile for each group;
identifying factors distinguishing the groups;
selecting one of the groups as a group of interest, identifying and assigning statistically nearest non-members to a hold-out dataset, and assigning to a training dataset all other members;
determining the probabilities that each individual belongs to each of the groups;
reassigning members within hold-out dataset to groups for which they have maximum probability
calculating for each group over the dataset population, the mean probability that individuals of the predetermined population will belong to that group; and repeating the above four steps until convergence, which is when no appreciable change occurs in the percentage share of predetermined population in the high-level class of interest between two consecutive iterations.
storing the mean probability for each group as part of the data in the dataset.

2. The method of claim 1, wherein the predetermined population of individuals of the dataset is a portion of a larger regional, national, or international population of individuals, and after completing the step of calculating the mean probability for each group over the dataset population, the method further comprises projecting the mean probability results for each group over the larger regional, national, or international population.

3. The method of claim 1, wherein the unit of analysis is an individual or even a group of individuals grouped on the basis of geographical proximity and/or other conditions.

4. The method of claim 1, wherein executing the refinement and/or segmentation utilizes a non-hierarchical k-Means clustering technique paired with a correlation distance metric or other clustering/segmentation techniques paired with other distance metric criterion.

5. The method of claim 1, wherein for each group, the representative member profile created for that group is the centroid, defined on the basis of mean or median of that group.

6. The method of claim 1, wherein the identification of factors that separate the groups is achieved by a machine learning or regression method.

7. The method of claim 1, wherein the identification of factors that separate the groups is achieved by a regression method such as stepwise multinomial logistic regression.

8. The method of claim 6, wherein an elimination scheme such as a backward elimination scheme is used for the stepwise multinomial logistic regression.

9. The method of claim 1, wherein distance metrics are utilized in the determination of those non-members who are statistically nearest to the representative member profile of the group of interest for determining elements of the hold-out dataset, while assigning all the remaining members to the training dataset.

10. The method of claim 1, wherein calculating the probability that each individual belongs to each of the groups is done by applying machine learning or regression method on the training dataset

11. The method of claim 10, wherein calculating the probability that each individual belongs to each of the groups is by stepwise multinomial logistic regression.

12. The method of claim 1, wherein for each group over the dataset population, calculating the mean probability that individuals of the predetermined population will belong to that group is achieved through a summation of the mean probability that each individual belongs to that group.

13. A system for generating a predictive model to be executed on data stored in a dataset corresponding to a predetermined population of individuals, where the dataset is managed by a database management system, the system comprising:
a classification module for executing a classification of the individuals into at least two high-level classes;
a segmentation module for executing a refinement and/or segmentation of the high-level classes of the individuals into a number of groups, and assigning each individual to one of the groups using a clustering methodology;
a membership profiling module for creating a representative member profile for each group;
a factor identification module identifying factors distinguishing the groups;
a training dataset module for assigning to a training dataset those individuals who are members of a predetermined group of interest and those members who are statistically farthest from the representative member profile of the group of interest, and assigning to a hold-out dataset all other members;
an individual probability calculation module for calculating the probabilities that each individual belongs to each group; and
a reassignment module for classifying members within hold-out dataset to groups for which they have maximum probability
a mean probability calculation module for calculating for each group over the dataset population, the mean probability that individuals of the predetermined population belong to that group and repeating the above four modules until convergence, which is when no appreciable change occurs in the percentage share of predetermined population in the high-level class of interest between two consecutive iterations.

14. The system of claim 13, wherein the predetermined population of individuals of the dataset is a portion of a larger regional, national, or international population of individuals, and wherein the system further comprises a projection module for projecting the mean probability results for each group over the larger regional, national, or international population.

15. The system of claim 13, wherein the segmentation module utilizes a non-hierarchical k-Means clustering technique paired with a correlation distance metric or other clustering/segmentation techniques paired with other distance metric criterion.

16. The system of claim 13, wherein for each group, the representative member profile created for that group by the membership profiling module is the centroid, defined on the basis of mean or median of that group.

17. The system of claim 13, wherein the factor identification module identifies factors distinguishing the groups through a machine learning or regression method.

18. The system of claim 13, wherein the factor identification module identifies factors distinguishing the groups through a regression method such as stepwise multinomial logistic regression.

19. The system of claim 18, wherein an elimination scheme such as a backward elimination scheme is used for the stepwise multinomial logistic regression.

20. The system of claim 13, wherein the hold-out dataset module uses distance metrics in the determination of those non-members who are statistically nearest to the representative member profile of the group of interest, while assigning all the remaining members to the training dataset.

21. The system of claim 13, wherein the individual probability calculation module uses a machine learning or regression method applied on the training dataset to calculate the probability for each individual to belong to each group for the entire dataset.

22. The system of claim 21, wherein the individual probability calculation module uses stepwise multinomial logistic regression to calculate the mean probability for each individual to belong to each group.

23. The system of claim 13, wherein for each group over the dataset population, the mean probability calculation module calculates the mean probability that individuals of the predetermined population will belong to that group through a summation of the mean probability that each individual belongs to that group.

24. A computer program product comprising a non-transitory machine-readable medium storing instructions, which when executed by a processor, cause a computer to perform a method for generating a predictive model to be executed on data stored in a dataset corresponding to a predetermined population of individuals, where the dataset is managed by a database management system, the instructions comprising:
executing a classification of the individuals into at least two high-level classes;
executing a refinement and/or segmentation of the high-level classes of individuals into a number of groups, and assigning each individual to one of the groups using a clustering methodology;
creating a representative member profile for each group;
identifying factors separating the groups;
selecting one of the groups as a group of interest, assigning to a training dataset those individuals who are members of the group of interest and those members who are statistically farthest from the representative member profile of the group of interest, and assigning to a hold-out dataset all other members;
determining the probabilities that each individual belongs to each of the groups;
reassigning members within hold-out dataset to groups for which they have maximum probability;
calculating for each group over the dataset population, the mean probability that individuals of the predetermined population belong to that group; and repeating the above four steps until convergence, which is when no appreciable change occurs in the percentage share of predetermined population in the high-level class of interest between two consecutive iterations.
storing the mean probability for each group as part of the data in the dataset.
